(19) United States
(12) Patent Application Publication
(10) Pub. No.: US 2025/0188855 A1
(43) Pub. Date: Jun. 12, 2025

(54) Two-Stroke Engine, Lubrication Device, and Cylinder

(71) Applicant: Marco Antonio Moté Soares, Teresópolis (BR)

(72) Inventor: Marco Antonio Moté Soares, Teresópolis (BR)

(21) Appl. No.: 18/846,009

(22) PCT Filed: Mar. 3, 2023
(86) PCT No.: PCT/BR2023/050074

§ 371 Date: Sep. 11, 2024

(30) Foreign Application Priority Data
Mar. 14, 2022 (BR) 1020220046832

(51) Int. Cl. F01M 1/08; F02F 1/20; F16J 9/06; F16J 9/20

(52) U.S. Cl. CPC F01M 1/08; F02F 1/20; F16J 9/06; F16J 9/20; F16J 9/206; F01M 2001/083

(57) ABSTRACT

Disclosed herein are a two-stroke internal combustion engine, a lubrication device, and a two-stroke combustion engine cylinder comprising the lubrication device. In the engine, the lubrication device defines jointly with a sliding portion of a piston and a portion of the cylinder, a lubrication fluid retention region, wherein the lubrication device provides lubrication fluid for the lubrication fluid retention region.

### CROSS-REFERENCE TO RELATED APPLICATIONS

This application is a U.S. National Phase Application that claims the benefit of the filing date of International PCT Application No. PCT/BR2023/050074, filed on Mar. 3, 2023, which claims priority to Brazilian Application No. BR102022004683-2, filed on Mar. 14, 2022, each of which is hereby incorporated by reference herein in its entirety.

### FIELD OF THE DISCLOSURE

The present disclosure refers to a two-stroke internal combustion engine, a lubrication device and a cylinder comprising the lubrication device. In particular, the present disclosure refers to a two-stroke internal combustion engine comprising a lubrication device, a two-stroke engine cylinder comprising a lubrication device and a lubrication device.

### BACKGROUND

Two-stroke engines are internal combustion engines known for having simple internal construction and good power-weight ratio when compared with four-stroke engines. Additionally, differently to a four-stroke engine, as working stages de two-stroke engines are not precisely demarcated, since the intake of gases into the combustion chamber occurs simultaneously to the exhaustion of gases coming from the combustion of the preceding cycle.

The simple construction characteristics of a two-stroke engine require the inclusion of lubricating oil directly in the fuel. The burning of oil in the combustion chamber of the engine, added to the fact that the intake is simultaneous to the exhaustion, results in more polluting exhaust fumes that are harmful to the environment compared to the exhaust fumes of a four-stroke engines.

Therefore, the increasingly stricter environmental regulations relating to the emittance of gases in internal combustion engines has made it unfeasible to manufacture countless two-stroke engines that were unable to conform to the new laws and environmental rules.

With a view to bringing two-stroke engines in line with the new trends in climate protection, avoiding waste and increasing the efficiency of said engines, countless inventions have been developed. One highly desirable solution to improve the quality of the exhaust fumes of two-stroke engines is the decrease or total withdrawal of the lubricating oil from the fuel used in these engines. In this sense, different internal adaptations in the engines need to be made to make this characteristic feasible.

An example of a document from the state of the art that describes a direct injection of oil is CN103174512. Said document describes a two-stroke engine comprising an oil ring positioned in the cylinder of the engine. The oil ring described comprises three elements which interact with each other to provide lubrication of the piston at specific points.

Another example of a document from the state of the art that describes reduced oil burning inside the cylinder is CN104088712. According to this document, the oil scraper ring reduces the consumption of oil of the two-stroke engine by providing an upper body, a lower body and a sinking groove with oil return orifice.

A third example of a document from the state of the art that describes a cylinder lubrication system for a two-stroke engine is document U.S. Pat. No. 9,926,821. In the system of said document, lubricating oil supply openings open up on the internal circumferential surface of the cylinder at a bottom point to an upper ring of a piston. The lubricating oil supply openings are configured to provide lubricating oil at specific points of the cylinder.

However, the solutions proposed in said documents do not keep the oil isolated from contact with the fuel and does not suitably and desirably avoid the burning of oil in the combustion chamber. Additionally, the solutions from the state of the art are hardly effective in terms of lubrication, because they do not carry out a control of a region where the oil is applied, but the application of oil at specific points and without restriction or oil dispersal control inside the cylinder.

### SUMMARY

In light of the problems described in the state of the art, various embodiments set forth herein provide a two-stroke internal combustion engine that avoids or mitigates the burning of lubrication fluid in the combustion chamber of the engine.

Various embodiments set forth herein also carry out an efficient lubrication of the cylinder of the two-stroke engine by avoiding lubrication fluid waste both by the burning and exhaustion thereof, to perform a suitable application of lubrication fluid and to maintain lubrication fluid in the region where the piston moves.

Additionally, various embodiments set forth herein provide an easy-to-assemble and easy-to-replace lubrication device both for the device and for the piston rings and other components of the engine.

Yet additionally, various embodiments set forth herein provide a two-stroke engine with efficient intake of the air-fuel mixture through an inlet element and/or a plurality of paddles comprised in the crankcase of the engine.

The present disclosure sets forth a two-stroke combustion engine, comprising a cylinder; a piston slidingly disposed inside the cylinder; and a lubrication device comprised perimetrally inside the cylinder. The lubrication device defines jointly with a sliding portion of the piston and a portion of the cylinder, a lubrication fluid retention region, wherein the lubrication device provides lubrication fluid for the lubrication fluid retention region.

Optionally, the lubrication device is also configured to remove excess lubrication fluid from the lubrication fluid retention region.

Optionally, the piston comprises a piston head, a skirt associated to the lower region of the piston head and a compression ring comprised between the piston head and the skirt. The lubrication device comprises a compression ring. The lubrication fluid retention region is defined between the compression ring of the lubrication device and the compression ring of the piston.

Optionally, the piston is configured to move upwardly and downwardly inside the cylinder between a top dead center and a bottom dead center, wherein, in the bottom dead center the compression ring of the piston is positioned adjacently to the lubrication device. The lubrication fluid retention region in the bottom dead center has a lower volume of lubrication fluid and the lubrication fluid retention region in the top dead center has a greater volume of lubrication fluid.

The present disclosure also sets forth a lubrication device, comprising a plurality of channels; and an oil ring configured to associate to one channel from the plurality of channels. The association of the oil ring with the channel from the plurality of channels establishes a perimeter lubrication fluid channel on the piston ring device.

Optionally, the oil ring comprises a ring format with C cross-section and a plurality of orifices on its vertical wall.

Optionally, the lubrication device further comprises a compression ring positioned in one channel from the plurality of channels different to the oil ring channel, wherein the compression ring comprises a ring format with rectangular cross-section, and wherein the inner surface of the compression ring is a straight angle surface configured to provide maximum contact between the compression ring and a piston wall.

Optionally, the lubrication device further comprises scraper rings positioned in channels different to each other and different to the channels of the oil ring and of the compression ring.

Optionally, the piston rings are comprised in the following order from top to bottom relative to the axis of the lubrication device: first scraper ring, oil ring, second scraper ring and compression ring.

Optionally, the lubrication device further comprises flexible rings positioned in the channels from the plurality of channels between the piston rings and the lubrication device.

The present disclosure also sets forth a two-stroke combustion engine cylinder comprising the lubrication device; and a piston positioned between a combustion chamber and a crankcase. The lubrication device is positioned in a concavity comprised perimetrally in the cylinder and aligned with a sliding portion of the piston.

Optionally, the piston comprises a piston head, a compression ring, and a skirt, wherein the piston head associates to the skirt and the compression ring is comprised between the piston head and the skirt.

Optionally, the skirt of the piston comprises a body free of orifices.

Optionally, the lubrication device comprises an inner diameter equal to the inner diameter of the cylinder wall.

Optionally, the cylinder further comprises a plurality of paddles positioned in the crankcase, wherein the plurality of paddles associates to a crankshaft, wherein the crankshaft associates to a rod, wherein the rod associates to the piston, wherein the movement of the piston shifts the plurality of paddles assisting with the intake of the air-fuel mixture.

Optionally, the plurality of paddles comprises paddles positioned parallel to each other and fastened to an encasement body, wherein the encasement body comprises an orifice positioned eccentrically relative to the encasement das paddles.

Optionally, the cylinder comprises an inlet element in a region adjacent to the crankcase, wherein the inlet element comprises intake orifices and reed valves.

### BRIEF DESCRIPTION OF THE DRAWINGS

The technology of the present disclosure will next be described in greater detail, based on an example of execution represented in the drawings. The figures show:

FIG. 1—a perspective view in cross-section of an embodiment of the cylinder of the present disclosure;

FIG. 2—a side view in cross-section of an embodiment of the cylinder of the present disclosure at bottom dead center;

FIG. 3—a front view in cross-section of an embodiment of the cylinder of the present disclosure at bottom dead center;

FIG. 4—a side view in cross-section of an embodiment of the cylinder of the present disclosure at top dead center;

FIG. 5—a front view in cross-section of an embodiment of the cylinder of the present disclosure at top dead center;

FIG. 6—a top view in cross-section of an embodiment of the cylinder of the present disclosure;

FIG. 7—a perspective view in cross-section of an embodiment of the lubrication device in cross-section of the present disclosure;

FIG. 8—a perspective view in cross-section of an embodiment of the lubrication device in cross-section of the present disclosure;

FIG. 9—a perspective view of an embodiment of the oil ring of the present disclosure;

FIG. 10—a perspective view in cross-section of an embodiment of the oil ring in cross-section of the present disclosure;

FIG. 11—a side view in cross-section of an embodiment of the oil ring of the present disclosure;

FIG. 12—a perspective view of an embodiment of the oil ring of the present disclosure;

FIG. 13—a blown-up view an embodiment of the piston of the present disclosure;

FIG. 14—a blown-up view an embodiment of the piston of the present disclosure;

FIG. 15—a perspective view of an embodiment of the piston and of the lubrication device in cross-section of the present disclosure;

FIG. 16—a perspective view of an embodiment of the piston and of the lubrication device of the present disclosure;

FIG. 17—a perspective view of an embodiment of the rod-crankshaft assembly of the present disclosure;

FIG. 18—a perspective view of an embodiment of the rod-crankshaft assembly of the present disclosure;

FIG. 19—a blown-up view an embodiment of the rod-crankshaft assembly of the present disclosure;

FIG. 20—a blown-up view an embodiment of the rod-crankshaft assembly of the present disclosure;

FIG. 21—a perspective view of an embodiment of the inlet element of the air-fuel mixture of the present disclosure;

FIG. 22—a perspective view of an embodiment of the inlet element of the air-fuel mixture of the present disclosure; and

FIG. 23—a cross-section view of an embodiment of the inlet element of the air-fuel mixture of the present disclosure.

### DETAILED DESCRIPTION OF THE DRAWINGS

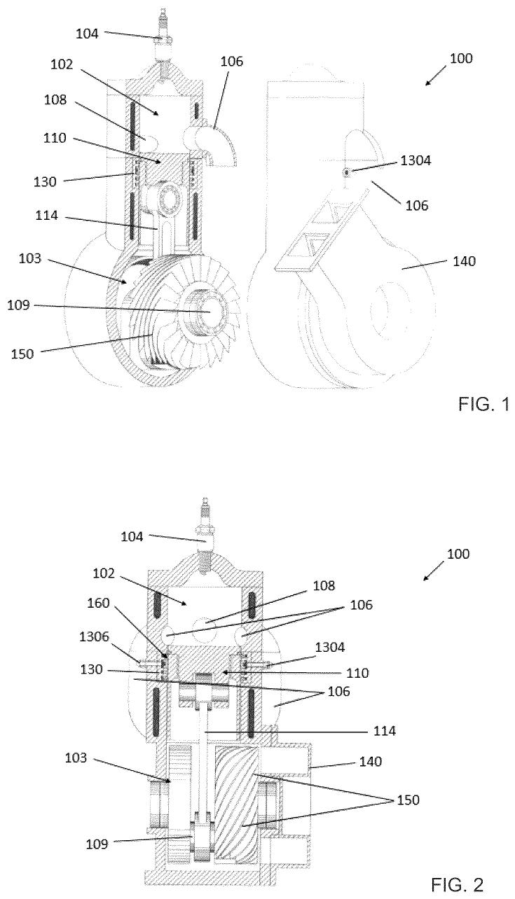

FIGS. 1 to 6 illustrate an embodiment of the cylinder 100 of the present disclosure. The cylinder 100 of the present disclosure comprises a combustion chamber 102, a crankcase 103, a spark plug 104, two transfer channels 106, an escape channel 108, a piston 110, a lubrication device 130, a rod 114, a crankshaft 109, an inlet element 140 of the air-fuel mixture and a plurality of paddles 150.

In this embodiment, the cylinder 100 illustrated is a two-stroke internal combustion engine cylinder. In this case, the cylinder 100 takes in an air-fuel mixture into the crankcase 103 through the inlet element 140 with assistance from the plurality of paddles 150, positioned in the crankcase 103, and from the vacuum generated by the movement of the piston 110.

The air-fuel mixture taken into the crankcase 103 through the inlet element 140 is transferred to the combustion chamber 102 through the transfer channels 106 when the piston 110 is at the bottom position. This position of the piston 110 releases the openings of the transfer channels 106 in the combustion chamber. In this moment, the escape channel 108 is also released, through where there occurs the withdrawal of the mixture resulting from the combustion in the preceding cycle, and still present in the combustion chamber 102.

When the piston 110 rises, the air-fuel mixture is compressed and, on reaching a certain point, the spark plug 104 generates a spark that provides the combustion of the air-fuel mixture. At this moment, since the escape 108 and transfer 106 channels are blocked by the piston 110, the increase in temperature of the mixture present in the combustion chamber 102 causes the gases to expand and moves the piston 110 downward, again releasing the escape 108 and transfer 106 channels. The downward movement of the piston 110 also creates a vacuum that draws the air-fuel mixture from the crankcase 103 to the combustion chamber 102, initiating a new rotation cycle of the piston 110.

As can be noted in FIGS. 1 to 6, the cylinder 100 is divided into two regions. The first is the crankcase 103, which takes in the air-fuel mixture through the inlet element 140. The second is the combustion chamber 102, which takes in the air-fuel mixture coming from the crankcase 103 through the transfer channels 106 and releases the gases resulting from the combustion through the escape channel 108. Therefore, the transfer channels 106 fluidly connect the crankcase 103 and the combustion chamber 102. The escape channel, in turn, fluidly connects the combustion chamber 102 to the outside of the cylinder for releasing the escape gases.

The piston 110 is mechanically connected to the crankshaft 109 through the rod 114. The rod 114 is responsible for transforming the longitudinal movement of the piston 110 in rotation movement in the crankshaft 109. Accordingly, the rod 114 connects to the piston 110 and to the crankshaft 109 by means of bearings 118. Therefore, the movement of the piston 110 through burning the air-fuel mixture shifts the rod 114 and, consequently, turns the crankshaft 109.

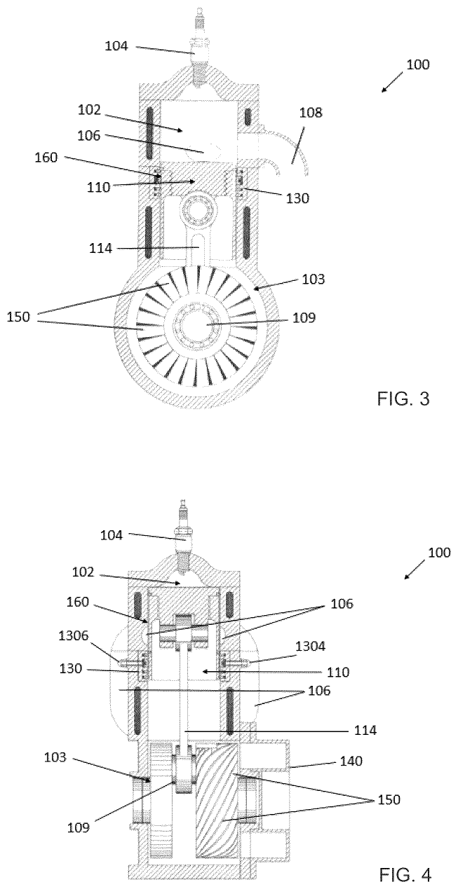

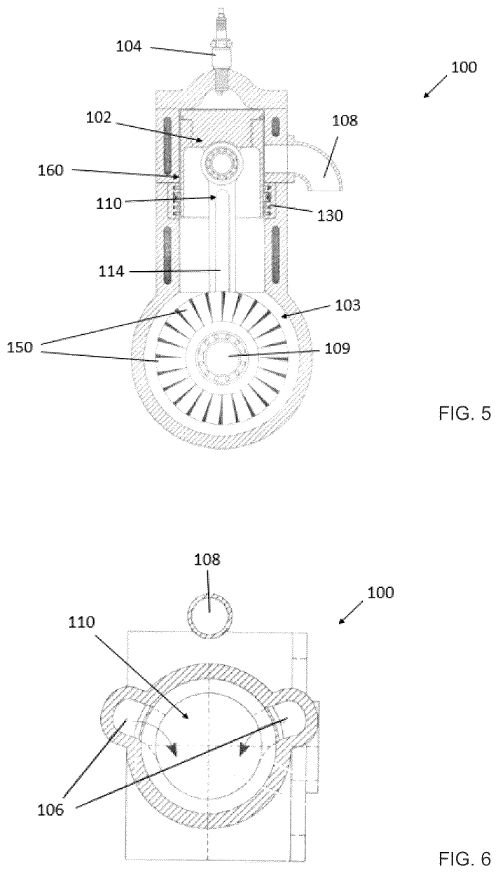

In the present embodiment, the piston 110 is slidingly disposed inside the cylinder 100 between the combustion chamber 102 and the crankcase 103. The piston 110 is aligned with the wall of the cylinder 100 and moves upwardly and downwardly, between a top dead center (FIGS. 4 and 5) and a bottom dead center (FIGS. 2 and 3), inside the cylinder 100, at the same time in which it prevents the fluid connection between the combustion chamber 102 and the crankcase 103. Consequently, the fluid connection between the crankcase 103 and the combustion chamber 102 occurs only through the transfer channels 106.

In order to prevent the exchange of gases and liquids between the combustion chamber 102 and the crankcase 103 (which should only occur through the transfer channels 106), the cylinder 100 of the present disclosure comprises the lubrication device 130. The lubrication device 130 is comprised perimetrally inside the cylinder and positioned in a concavity comprised perimetrally in the cylinder 110 and aligned with a sliding portion of the piston 110.

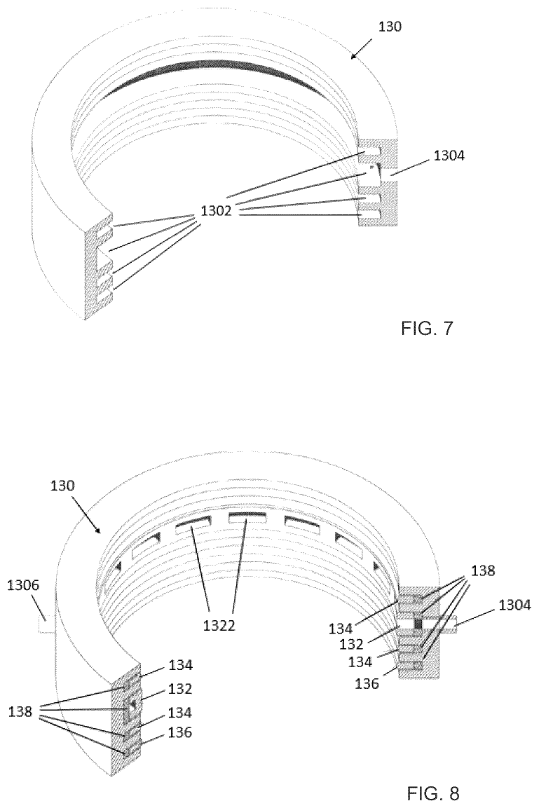

FIGS. 7 and 8 illustrate an embodiment of the lubrication device 130 of the present disclosure. In this embodiment, the lubrication device 130 comprises a cylindrical ring format with inner diameter equal to the inner diameter of the wall of the cylinder 100 (visible in FIGS. 1 to 5).

The lubrication device 130 comprises a plurality of channels 1302 disposed on its inner surface. These channels 1302 are concavities configured to receive piston rings 132, 134, 136 with different purposes. In the present embodiment, the lubrication device 130 is configured to comprise the following piston rings 132, 134, 136 in the plurality of channels 1302: an oil ring 132, two scraper rings 134 and a compression ring 136.

Accordingly, in the embodiment illustrated, the lubrication device 130 comprises four channels 1302. In this embodiment, the channel 1302 configured to receive the oil ring 132, in this case, the second channel from top to bottom relative to the axis of the lubrication device 130, has a greater height than the others. However, in other embodiments, different heights can be used for the channels 1302, depending on the type and size of the ring that each channel 1302 will receive. Additionally, the amount of piston rings comprised in the lubrication device 130 may also vary, as may the types of piston rings. In this way, the total number of channels 1302 present in the lubrication device 130 and their dimensions may vary.

The lubrication device 130 also comprises an oil inlet 1304 and an oil outlet 1306. The oil inlet 1304 and the oil outlet 1306 are orifices comprised in the lubrication device 130 at the height of the channel 1302 configured to receive the oil ring 132. Therefore, the lubrication fluid coming from outside sources can flow through the oil inlet 1304 of the lubrication device 130 to the oil ring 132. In the same way, the lubrication fluid present in the lubrication device 130 can flow out of the lubrication device 130 through the oil outlet 1306. The oil inlet 1304 and the oil outlet 1306 are positioned at diametrically opposite sites of the lubrication device 130 and extend outwardly of the lubrication device 130, where they interact with inlet channels and oil outlet (not illustrated). The lubrication fluid can be provided from sources outside the cylinder 100, from a lubrication fluid pump, for example.

In the embodiment illustrated, the lubrication device 130 comprises two scraper rings 134. The scraper rings 134 are responsible for removing excess lubrication fluid in contact with the walls and keep just a fine layer of lubrication fluid, dispersing the lubrication fluid homogenously on the inner walls of the cylinder 100 and a sliding portion of the piston 110. This fine layer of lubrication fluid decreases the attrition between the walls of the cylinder 100 and the sliding portion of the piston 110.

The scraper rings 134 comprise a ring format with rectangular trapezium-shaped cross-section configured to associate with the channels 1302 of the lubrication device 130. The inner surface of the scraper rings 134 comprises an angulation that removes and disperses the lubrication fluid as mentioned.

In the embodiment illustrated, the lubrication device 130 also comprises the compression ring 136. The compression ring 136 is responsible for maintaining the pressure difference between the crankcase 103 and the combustion chamber 102 and prevents or mitigates the mixture between the lubrication fluid introduced by the lubrication device 130 and the gases/fluids present in the crankcase 103.

The compression ring 136 comprises a ring format with rectangular cross-section configured to associate with the channel 1302 of the lubrication device 130. The inner surface of the compression ring 136 is a straight angle surface configured to provide maximum contact between the compression ring 136 and the wall of the piston 110.

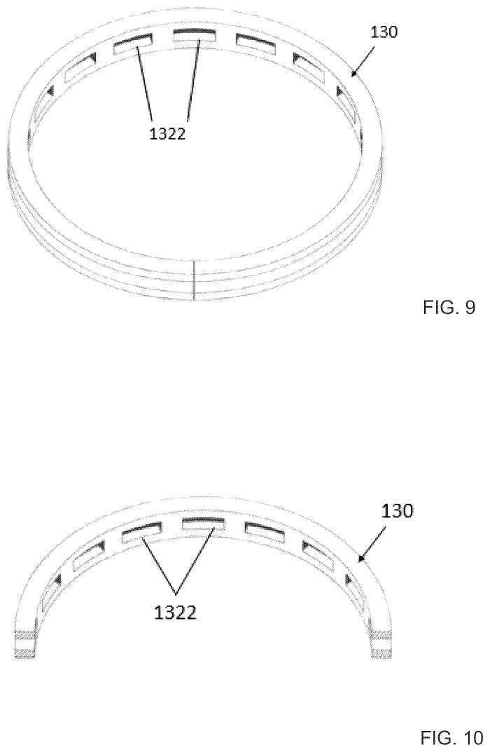

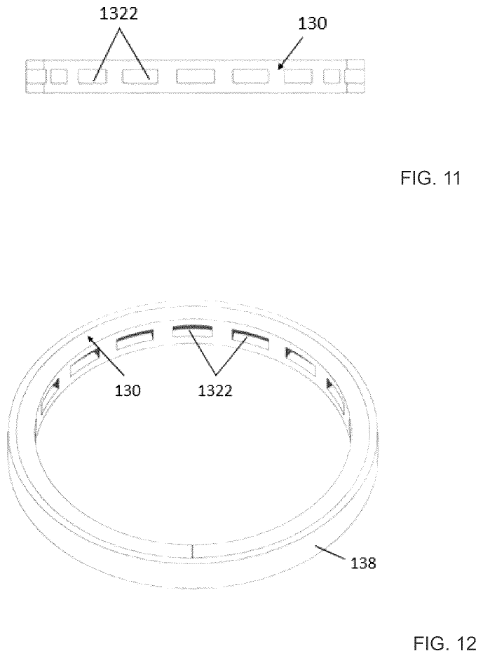

In the embodiment illustrated, the lubrication device 130 also comprises the oil ring 132. The oil ring 132 comprised in the lubrication device 130 is illustrated in FIG. 8 and in isolation in greater detail in FIGS. 9 to 12.

The oil ring 132 comprises a ring format, configured to associate with the channel 1302, and with C cross-section. The opening of the C cross-section faces the outer side of the ring. So, in associating with the lubrication device 130 or a flexible ring 138, the oil ring 132 establishes a perimeter lubrication fluid channel in the device that enables the outflow of the lubrication fluid and distribution thereof homogenously perimetrally to the lubrication device 130.

In the embodiment illustrated, the oil ring 132 comprises a plurality of orifices 1322 on its vertical wall. The plurality of orifices 1322 enables the outflow of the lubrication fluid between the channel generated by the oil ring 132 and the inner region of the cylinder 100. Thus lubrication fluid will interact with the piston 110, the cylinder 100 and with the other piston rings 134, 136.

In this embodiment, the orifices 1322 of the plurality of orifices 1322 are disposed along the entire wall of the oil ring 132 and spaced equidistantly. The orifices 1322 comprise a rectangular format with greater length than height. In other embodiments, the orifices 1322 may present different sizes, formats and distances between each other.

In the embodiment illustrated, the lubrication device 130 further comprises flexible rings 138. The flexible rings 138 are rings heat-resistant and made of flexible material, such as, for example, a type of rubber, the purpose of which is to press the piston rings 132, 134, 136 keeping them in constant contact with the piston 110. Therefore, the flexible rings 138 are rings positioned in the channels 1302 between the piston rings 132, 134, 136 and the lubrication device 130.

The flexible ring 138 associated to the oil ring 132 is also responsible for retaining the lubrication fluid on the oil ring 132, preventing the lubrication fluid from flowing through the gap existing between the oil ring 132 and the channel 1302. The flexible ring 138 associated to the oil ring 132 also comprises orifices that enable the passage of lubrication fluid through the oil inlet 1304 and through the lubrication fluid outlet 1306 comprised in the lubrication device 130.

In the embodiment illustrated, the lubrication device 130 comprises the piston rings 132, 134, 136 in the following order from top to bottom relative to the axis of the lubrication device 130: first scraper ring 134, oil ring 132, second scraper ring 134 and compression ring 136. This configuration of the piston rings 132, 134, 136 increases the efficiency of use of lubrication fluid in the engine, prevents or mitigates the burning of lubrication fluid junto with the air-fuel mixture and prevents or mitigates the passage of lubrication fluid to the crankcase 103.

As a consequence of the characteristics described, the lubrication device 130 increases the performance of the engine, increases the efficiency of the lubrication fluid, prevents or reduces the burning of lubrication fluid and provides an engine that produces less polluting exhaust fumes.

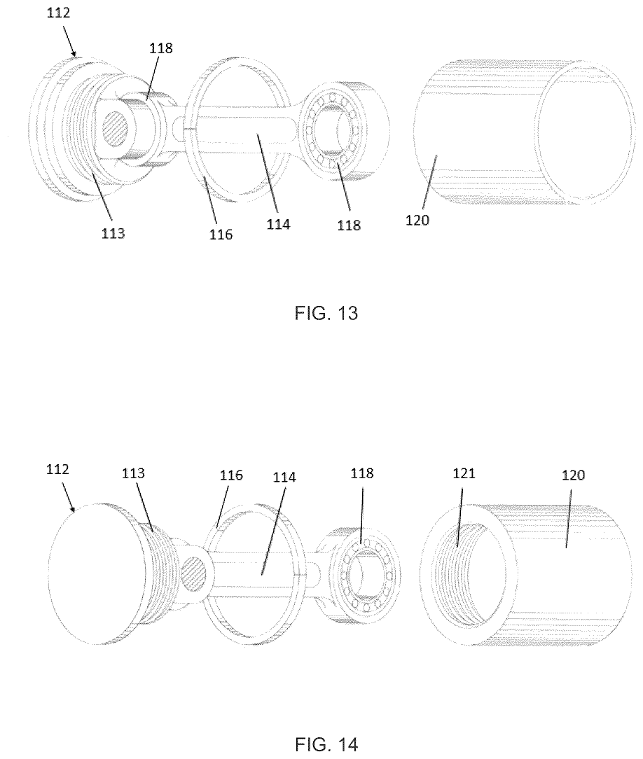

FIGS. 13 and 14 illustrate an embodiment of the piston 110 associated to the rod 114 of the present disclosure. The piston 110 comprises a piston head 112, a compression ring 116, a bearing 118 and a skirt 120.

The piston head 112 is the component of the piston 110 exposed to the combustion chamber 102 of the cylinder 100. Accordingly, the piston head 112 is configured to withstand the heat and the pressure generated during the combustion of the air-fuel mixture. In the embodiment illustrated, the surface of the piston head 112 exposed to the combustion chamber 102 is a flat surface. However, other surface formats can be used.

The piston head 112 also comprises a thread 113 configured to associate to a thread 121 comprised on the inner surface of the skirt 120. Thus, the threads 113, 121 enable the association of the piston head 112 with the skirt 120. The compression ring 116 is comprised on the piston 110 between the piston head 112 and the skirt 120. By way of the threaded skirt 120 on the piston head 112, the compression ring 116 is fastened onto the piston 110.

The compression ring 116 of the piston 110 has the same purpose as the compression ring 136 of the lubrication device 130, to maintain the pressure difference between the crankcase 103 and the combustion chamber 102. Additionally, the compression ring 116 of the piston 110 prevents or mitigates the mixture of the lubrication fluid introduced by the lubrication device 130 with the gases/fluids present in the combustion chamber 102. Additionally, the compression ring 116 helps dissipate part of the heat of the piston 110 to the cylinder 100, improving the internal temperature control of the engine.

The compression ring 116 of the piston 110 comprises a ring format with rectangular cross-section configured to associate with the head of the piston 112 and with the skirt 120. The outer surface of the compression ring 116 interacts with the wall of the cylinder 100 during the movement of the piston 110. Thus, the outer wall of the compression ring 116 comprises a surface parallel to the surface of the inner wall of the cylinder 100 so as to provide maximum contact between the compression ring 116 and the wall of the cylinder 100.

The skirt 120 of the piston 110 comprises a sliding portion of the piston and has a cylindrical ring format with an outer diameter smaller than the diameter of the inner wall of the cylinder 100. Additionally, the skirt 120 comprises a body free of orifices on its surface. The orifice-free body of the skirt 120 prevents the passage of the lubrication fluid into the piston 110 and into the crankcase 103, preventing the burning of lubrication fluid together with the air-fuel mixture.

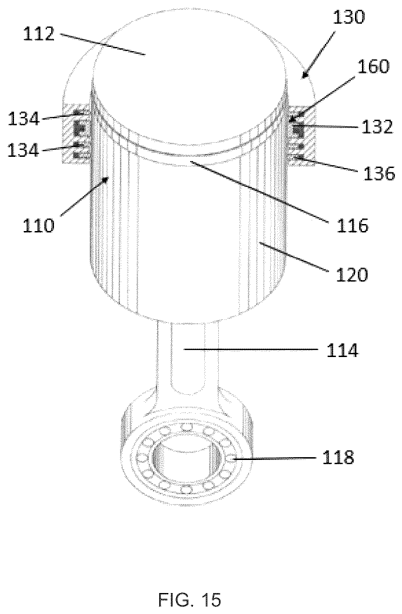

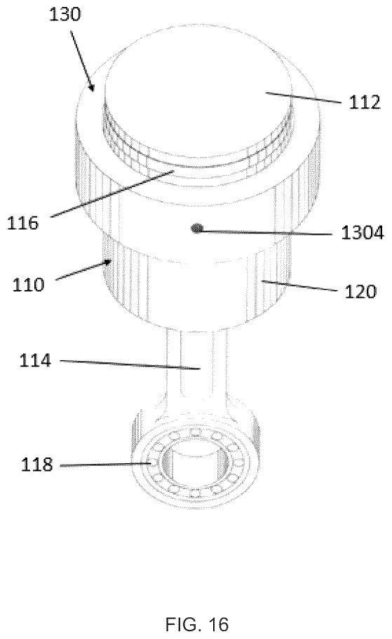

FIGS. 15 and 16 illustrate the lubrication device 130 in association with the piston 110 according to an embodiment of the present disclosure. In the cylinder 100, the lubrication device 130 is positioned in a region next to the skirt 120 of the piston and where the piston 110 moves longitudinally.

As can be noted, the compression ring 136 of the lubrication device 130 interacts with the surface of the skirt 120 of the piston 110. The compression ring 116 of the piston 110 interacts with the surface of the cylinder 100 (visible in FIGS. 1 to 5). Therefore, while the engine is running, the lubrication fluid is basically maintained in the region between compression ring 136 of the lubrication device 130 and the compression ring 116 of the piston 110, called lubrication fluid retention region 160. Consequently, the present disclosure prevents the mixture of the lubrication fluid with the air-fuel mixture, also preventing the burning of lubrication fluid and reducing the degree of pollution of the engine's exhaust fumes.

The lubrication fluid retention region 160 is defined between the lubrication device 130 jointly with a sliding portion or skirt 120 of the piston 110 and a portion of the cylinder 100. Additionally, as mentioned, the lubrication fluid retention region 160 is defined between the compression ring 136 of the lubrication device 130 and the compression ring 116 of the piston 110.

For the correct working of the engine of the present disclosure, the lubrication fluid retention region 160 receives lubrication fluid through the lubrication device 130. In other words, the lubrication device 130 provides lubrication fluid for the lubrication fluid retention region 160. The lubrication device 130 is also configured to remove excess lubrication fluid from the lubrication fluid retention region 160.

The definition of the lubrication fluid retention region 160 by the two-stroke engine of the present disclosure prevents the mixture of the lubrication fluid with the air-fuel mixture, the burning of lubrication fluid in the combustion chamber and improves the quality of the exhaust fumes of the two-stroke engine.

In the present embodiment, the movement of the piston 110 relative to the lubrication device 130 helps to disperse the lubrication fluid on the surfaces in contact, enabling the lubrication of the surfaces of the piston 110 and of the cylinder 100 where the lubrication fluid should be applied. On moving upwards, the piston 110 carries the lubrication fluid distributed by the lubrication device 130 along the inner surface of the cylinder 100. On returning downwards, the compression ring 116 of the piston 100 interacts with the lubrication fluid present on the surface of the cylinder 100. Additionally, in moving downwards, the piston 100, which carries lubrication fluid on the outer surface of the skirt 120, makes the lubrication fluid interact with the compression ring 136 of the lubrication device 130 as well.

During its upward and downward movement, the piston 110 reaches the top dead center and the bottom dead center. At the bottom dead center, the compression ring 116 of the piston 110 is positioned adjacently to the lubrication device 130 and at the shortest distance from the compression ring 136 of the lubrication device 130. At the top dead center, the compression ring 116 of the piston 110 is at the furthest distance from the compression ring 136 of the lubrication device 130. Consequently, at the bottom dead center of the piston, the lubrication fluid retention region 160 has a lower volume of lubrication fluid and, at the top dead center of the piston 110, the lubrication fluid retention region 160 has a greater volume of lubrication fluid. Therefore, the lubrication fluid retention region 160 has a variable volume, which increases as the compression rings 116, 136 move away and decreases as the compression rings 116, 136 draw near.

The scraper rings 134 of the lubrication device 130 control the amount of lubrication fluid distributed on the surfaces of the skirt 120 of the piston 110 and cylinder 100, and keep a greater amount of lubrication fluid between them, that is, in the proximities of the oil ring 132, through where the lubrication fluid enters and leaves the cylinder 100.

In maintaining the lubrication fluid of the engine in a specific region inside the cylinder and separated from the air-fuel mixture, the lubrication fluid is not burned jointly with the air-fuel mixture, improving the quality of the exhaust fumes of the engine and enabling a two-stroke engine to meet stricter environmental requirements against pollution.

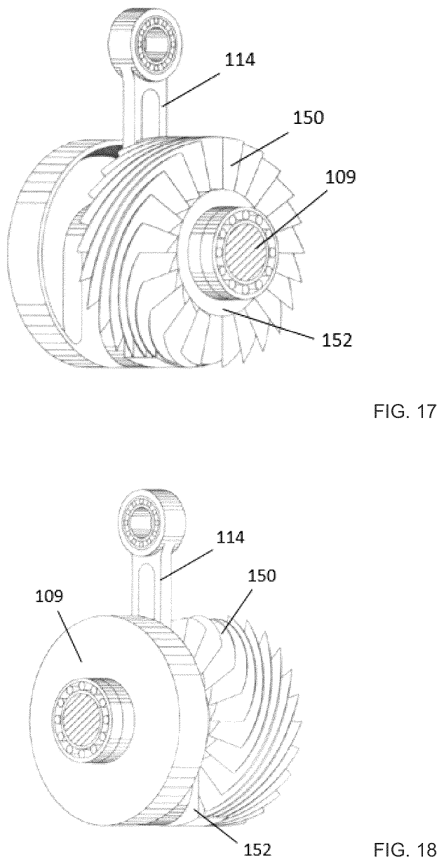

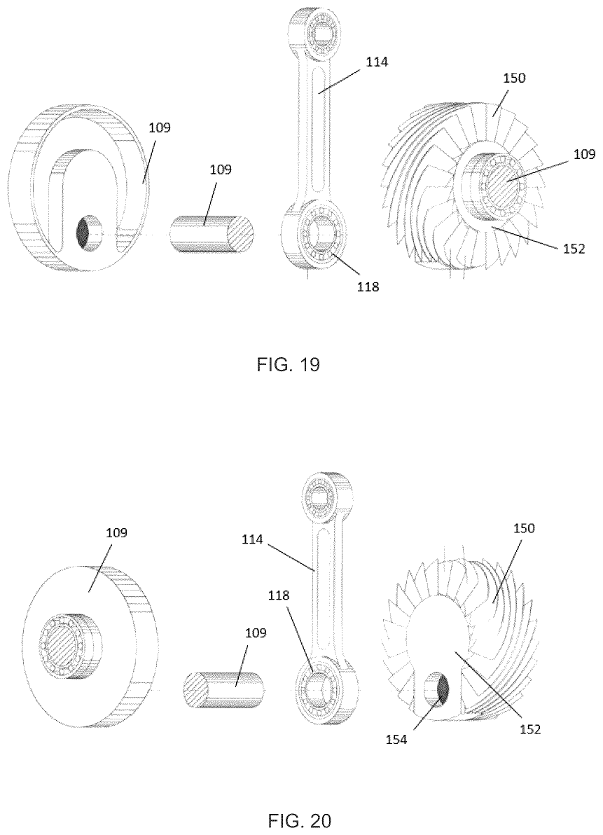

FIGS. 17 to 20 illustrate the plurality of paddles 150 of the present disclosure in association with the crankshaft 109 and the crankshaft 109 in association with the rod 114, through the bearing 118. As already described, the movement of the piston 110 shifts the rod 114, which, in turn, provides rotation of the crankshaft 109. In the embodiment illustrated, the rotation of the crankshaft 109 provides the rotation of the plurality of paddles 150.

The plurality of paddles 150 is a component of the cylinder 100 comprising a set of multiple paddles positioned substantially parallel to each other and fastened to an encasement body 152. The paddles of the plurality of paddles 150 are configured, based on the rotation of the plurality of paddles 150, to assist with the intake of the air-fuel mixture in the crankcase 103 creating a pressure difference that provides the flow of the air-fuel mixture into the crankcase 103.

The encasement body 152 of the plurality of paddles 150 comprises a cylindrical format with a body extension comprising an orifice 154, where the axis of the crankshaft 109 is encased, which associates to the rod 114. The orifice 154 of the encasement body 152 is positioned eccentrically relative to the encasement of the paddles. A second crankshaft axis is positioned concentrically to the encasement of the paddles. Consequently, the movement of the rod 114 provides the rotation of the crankshaft 109 and, consequently, the rotation of the plurality of paddles 150.

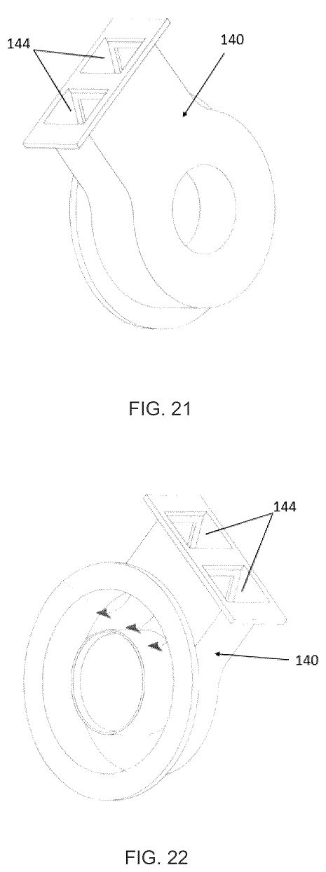

FIGS. 21 to 23 illustrate the inlet element 140 of the air-fuel mixture of the present disclosure. The inlet element 140 is positioned on the outside of the cylinder 100 in a region adjacent to the crankcase 103 and is responsible for the intake of the air-fuel mixture into the cylinder 100.

In the embodiment illustrated, the inlet element 140 comprises an O-shaped body with a rectangular extension that fluidly connects the inside of the cylinder 100 with the outside. The extension of the body comprises two intake orifices 144 where the air-fuel mixture passes through. The inlet element 140 opens into the crankcase 103 in the region of the O-shaped body, as shown in FIG. 22, where the arrows illustrate the intake of the air-fuel mixture in the crankcase 103 of the cylinder 100.

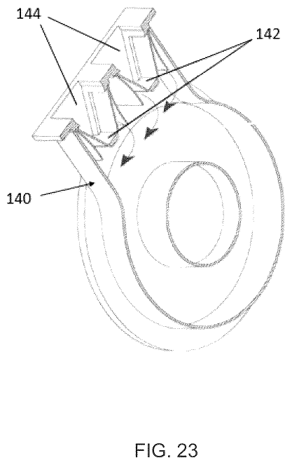

In each intake orifice 144, the inlet element 140 comprises a reed valve 142. The reed valve 142 is a valve comprising one or more reeds which open to the passage of the air-fuel mixture towards the entrance in the inlet element 140, but close if there is pressure in the opposite direction, blocking the outlet of the air-fuel mixture of the cylinder 100. FIG. 23 shows the flow of the air-fuel mixture into the inlet element 140 through the intake orifices 144 and the reed valves 142.

The inlet element 140 is simple to manufacture owing to the simplicity of the components at the same time in which it allows an efficient intake of the air-fuel mixture into the inner region of the crankcase 103 of the cylinder 100.

Having described examples of embodiments, it should be understood that the scope of the present disclosure encompasses other possible variations, being limited solely by the content of the accompanying claims, potential equivalents included therein.

1-19. (canceled)

20. A two-stroke combustion engine, comprising:
a cylinder comprising a concavity positioned perimetrally;
a piston slidingly disposed inside the cylinder and comprising a compression ring; and
a lubrication device housed perimetrally in the concavity and aligned with a sliding portion of the piston, the lubrication device comprising a compression ring,
the lubrication device defining a lubrication fluid retention region jointly with a sliding portion of the piston, a portion of the cylinder, the compression ring of the lubrication device and the compression ring of the piston, wherein the lubrication device provides lubrication fluid for the lubrication fluid retention region.

21. The two-stroke engine according to claim 20, wherein the piston comprises a piston head, a skirt associated to the lower region of the piston head and a compression ring comprised between the piston head and the skirt.

22. The two-stroke engine according to claim 21, wherein the piston is configured to move upwardly and downwardly inside the cylinder between a top dead center and a bottom dead center, wherein, at the bottom dead center the compression ring of the piston is positioned adjacently to the lubrication device.

23. The two-stroke engine according to claim 22, wherein the lubrication fluid retention region at the bottom dead center has a lower volume of lubrication fluid and that the lubrication fluid retention region at the top dead center has a greater volume of lubrication fluid.

24. A lubrication device, comprising:
a plurality of channels;
an oil ring positioned in one channel from the plurality of channels, wherein the position of the oil ring in the channel from the plurality of channels establishes a perimeter lubrication fluid channel on the lubrication device;
a compression ring which comprises a ring format with rectangular cross-section, and wherein the inner surface of the compression ring is a straight angle surface configured to provide maximum contact between the compression ring and a piston wall, wherein the compression ring is positioned in one channel of the plurality of channels different from the channel of the oil ring; and
scraper rings, wherein the scraper rings are positioned in channels of the plurality of channels different from each other and different from the channels of the oil ring and of the compression ring.

25. The lubrication device according to claim 24, wherein the oil ring comprises a ring format with C cross-section and a plurality of orifices on its vertical wall.

26. The lubrication device according to claim 25, wherein the rings are comprised in the following order from top to bottom relative to the axis of the lubrication device: first scraper ring, oil ring, second scraper ring and compression ring.

27. The lubrication device according to claim 26, further comprising flexible rings positioned in the channels of the plurality of channels between the piston rings and the lubrication device.

28. A two-stroke combustion engine cylinder, comprising:
a piston comprising a compression ring;
a concavity positioned perimetrally inside the cylinder; and
the lubrication device as defined in claim 5, wherein the lubrication device is positioned in the concavity of the cylinder and aligned with a sliding portion of the piston, wherein the lubrication device defines a lubrication fluid retention region jointly with a sliding portion of the piston, a portion of the cylinder, the compression ring of the lubrication device and the compression ring of the piston, wherein the lubrication device provides lubrication fluid for the lubrication fluid retention region.

29. The cylinder according to claim 28, wherein the piston comprises a piston head, a compression ring, and a skirt, wherein the piston head associates to the skirt and the compression ring is comprised between the piston head and the skirt.

30. The cylinder according to claim 29, wherein the skirt of the piston comprises a body free of orifices.

31. The cylinder according to claim 30, wherein the lubrication device comprises an inner diameter equal to the inner diameter of the wall of the cylinder.

32. The cylinder according to claim 31, further comprising a plurality of paddles positioned in the crankcase, wherein the plurality of paddles associates to a crankshaft, wherein the crankshaft associates to a rod, wherein the rod associates to the piston, wherein the movement of the piston shifts the plurality of paddles assisting with the intake of the air-fuel mixture.

33. The cylinder according to claim 32, wherein the plurality of paddles comprises paddles positioned parallel to each other and fastened to an encasement body, wherein the encasement body comprises an orifice positioned eccentrically relative to the encasement of the paddles.

34. The cylinder according to claim 33, comprising an inlet element in a region adjacent to the crankcase, wherein the inlet element comprises intake orifices and reed valves.
